(19) United States
(12) Patent Application Publication
(10) Pub. No.: US 2010/0117857 A1
(43) Pub. Date: May 13, 2010

(54) Telemetry services: serving the utility companies using the home FTTP network environment

(76) Inventors: Sam Russell, Tinton Falls, NJ (US); Paritosh Bajpay, Edison, NJ (US); David H. Lu, Morganville, NJ (US)

Correspondence Address: AT& T LEGAL DEPARTMENT - Monka;ATTN: PATENT DOCKETING, ROOM 2A - 207, ONE AT & T WAY, BEDMINSTER, NJ, 07921, US

(21) Appl. No.: 12/291,197

(22) Filed: Nov. 7, 2008

(51) Int. Cl. G08C 15/00

(52) U.S. Cl. 340/870.02

(57) ABSTRACT

A system and method for collecting utility consumption telemetry data from a customer served by a plurality of utility companies, and providing a consumption report for the customer to each of the plurality of utility companies serving the customer. The system includes a utility server that is adapted for receiving the utility consumption telemetry data from the utility customer. The utility server is disposed at a network service provider that serves the customer with bundled network services. Utility consumption telemetry data is stored in a database and consumption reports for the customer may be generated for each of the plurality of utility companies serving the customer.

### FIELD OF THE INVENTION

The present invention relates generally to computer networking, and more particularly, to systems and methods that enable the collection of digital telemetry data relating to utility consumption at a customer premises over a service provider's network serving the customer.

### BACKGROUND OF THE INVENTION

Utility companies (i.e., water, electric, and gas) typically bill a customer by reading meters that are disposed at the customer's premises. In most residential and small business applications, utility meters are placed outside of the home or business location, and these are visually inspected by utility company employees to collect utility usage data. In order to save the costs associated with sending these employees out on monthly meter reading trips, some utility companies estimate charges based on previous consumption. However, this has proven problematic for some customers as they can be charged more during the months when charges are estimated than for actual consumption. Accordingly, there have been proposals to reduce the labor involved in collecting utility usage data.

Many types of “automatic meter reading” (AMR) technologies have been proposed to overcome the disadvantages associated with manual meter readings taken by utility company employees. AMR expedients include handheld, mobile and network technologies based on telephony platforms, radio frequency (RF), or powerline transmission.

U.S. Pat. No. 5,699,276 to Roos, discloses a utility meter interface that

connected between a utility company and a residence. The utility meter interface includes a utility meter for measuring utility consumption at the residence, and a computer located externally to the home. The computer is connected to the utility meter and provides an interface between a communication network provided by the utility company and electrical, video and telephone devices in the home. An electric company can produce a record of power use by communicating periodically with the meter interface over the communication network.

U.S. Pat. No. 6,369,719 to Tracey et al. discloses a system and method for remotely monitoring utility consumption by automatically collecting data and digitally transmitting the data to a remote receiving device via a wireless network (i.e., GSM or TDMA), or through a hardwired telecommunications system at a user location for subsequent transmission to the wireless network.

U.S. Publ. No. 2007/0055640 to Dababneh et al. discloses a system and method for remotely monitoring a plurality of utility meters that by interrogating the meters with SMS messages over a GSM network. A host computer at a billing office of the utility uses SMS to contact one or more utility meters using a mobile link. The utility meters respond with a SMS message containing usage data that is then stored in a database to enable a record of utility consumption to be generated for the customer.

Although the remote collection of utility data is known as evidenced by the above, the inventors are unaware of any system or method wherein a telecommunication service provider's network is employed to collect and maintain utility meter consumption data for customers at a utility server operated by the network service provider, and where such a server may be accessed by both the utility companies and the customers.

### SUMMARY OF THE INVENTION

In accordance with an aspect of the invention, there is provided a method for collecting utility consumption telemetry data from a customer served by a plurality of utility companies, and providing a consumption report for the customer to each of the plurality of utility companies serving the customer. The method generally comprises the steps of: receiving the utility consumption telemetry data from the utility customer at a server associated with a network service provider that provides the customer with networked communications; storing the utility consumption telemetry data in a database; and providing a consumption report for the customer to each of the plurality of utility companies serving the customer.

In a preferred expedient, network service provider includes bundled home services for the customer, such as voice, data and television.

The consumption reports that are generated include at least one of monthly, quarterly and annual reports. The method may include the step of generating an email notification to each of the plurality of utility companies in connection with providing the consumption report.

The method may also comprise the step of receiving alarm data relating to the condition of a utility meter at the customer location. An email notification can be sent to a selected utility company in connection with receiving the alarm data relating to the condition of the utility meter at the customer location.

In accordance with another aspect of the invention, there is provided a system for collecting utility consumption telemetry data from a customer served by a plurality of utility companies, and providing a consumption report for the customer to each of the plurality of utility companies serving the customer. The system comprises: a server associated with a network service provider that provides the customer with networked communications, adapted for receiving the utility consumption telemetry data from the utility customer, and storing the utility consumption telemetry data in a database; and a module for providing a consumption report for the customer to each of the plurality of utility companies serving the customer.

In accordance with yet another aspect of the invention, there is provided a system for collecting utility consumption telemetry data from a customer served by a plurality of utility companies, and providing a consumption report for the customer to each of the plurality of utility companies serving the customer, comprising: a plurality of utility meters disposed at the customer location, the utility meters communicating with a service provider network serving the customer; and a network service provider gateway coupled to the plurality of utility meters, the network service provider gateway enabling the delivery of bundled network services to the customer.

These aspects of the invention and further advantages thereof will become apparent to those skilled in the art as the present invention is described with particular reference to the accompanying drawings

### BRIEF DESCRIPTION OF THE DRAWINGS

FIG. 1 is a schematic of an exemplary network architecture for implementing aspects of the invention;

FIG. 2 is a schematic of a home network at a customer site that includes networked utility meters that communicate with a service provider network serving the customer;

FIG. 3 is an exemplary architecture of an IPTV network serving a customer with bundled services and adapted for implementing aspects of the invention; and

FIG. 4 is a flowchart of a method in accordance with an aspect of the invention.

### DETAILED DESCRIPTION OF THE INVENTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein are meant to encompass the items listed thereafter and equivalents thereof as well as additional items.

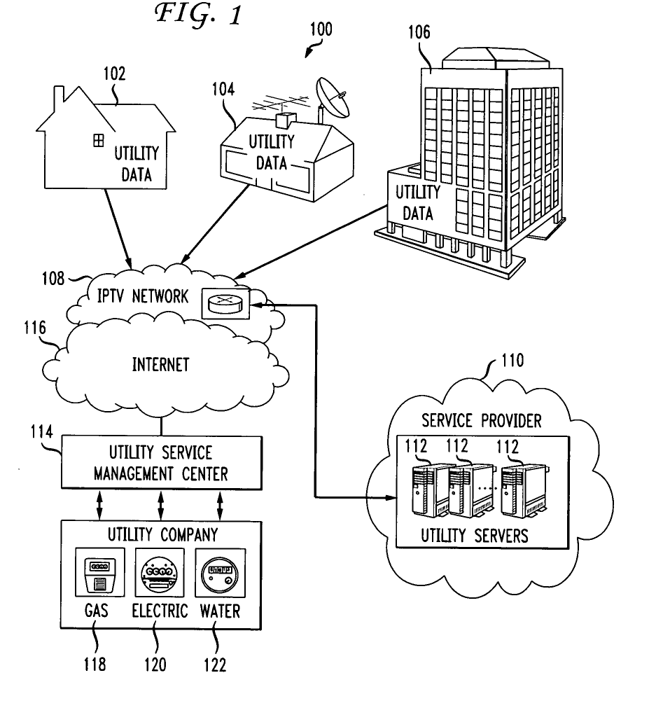

Referring now to FIG. 1, there is depicted a schematic diagram of an exemplary network architecture 100 for implementing aspects of the invention. A plurality of customers, identified here as a home residence 102, small business 104 and residential complex 106, are coupled to an Internet Protocol TV (“IPTV”) network serving those respective customers generally identified by the reference numeral 108. These networks enable a service provider 110 to provide bundled TV, Internet and phone service to customers in a manner well known in the art. The IPTV network may be Fiber to the Neighborhood (“FTTN”), which refers to implementations where fiber-optic cables are run to a cabinet serving a neighborhood, and then traditional coaxial or twisted pair wiring serve the home via either cable or A/VDSL communications. Alternatively, the IPTV network may be a Fiber to the Premises or home (“FTTP”), which directly connects fiber-optic cables to the customer's residence/structure. An aspect of the invention provides at least one utility server 112 that resides with the service provider 110, and which receives utility data captured from each customer 102, 104 and 106 via network 108, and stores utility data for each customer 102, 104 and 106, in addition to other functions that will be explained in greater detail below. A Utility Service Management Center (USMC) 114 communicates with the utility server 112 via the Internet 116, and with the various utility companies such as water 118, electric 120 and gas 122. The functions of the USMC 114 will also be described in more detail below.

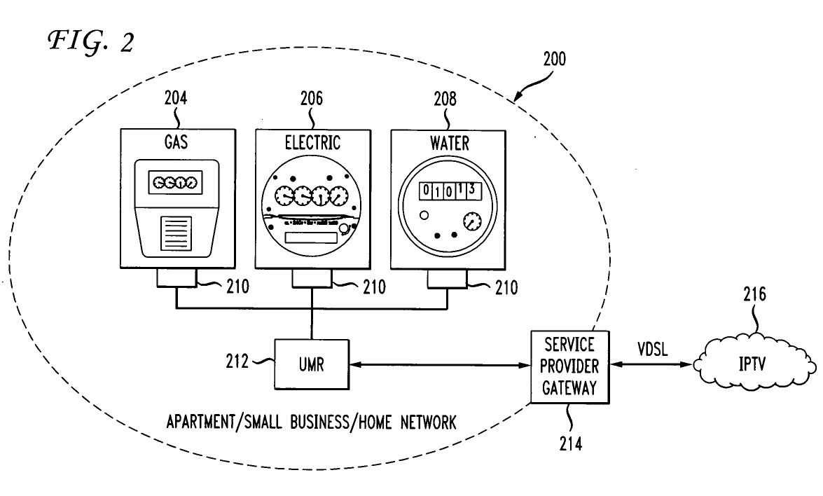

FIG. 2 is a schematic of a home network 200 at a customer site, which communicates with a plurality of utility meters: gas 204, electric 206 and water 208. Each utility meter has a data receiving device 210 for collecting consumption data from the meter. These types of receivers are known in the art, and may include a pulse initiator for converting mechanical usage readings into digital signals in the case of mechanical meters. Modern digital utility meters need not convert usage readings into digital signals and are thus capable to directly output the usage readings as digital data. The data receiving device may communicate with a meter interface unit such as a Universal Meter Reader (“UMR”) 212 which collects, stores and aggregates the information obtained from the individual meters and prepares the data for transmission over the home network 200. The UMR 212 is coupled to a service provider gateway 214 that communicates with an IPTV network (in the exemplary embodiment) shown generally at 216. The service provider gateway 214 may be an ADSL, VDSL, cable, or like modem. In the example shown, a VDSL connection is illustrated and described in more detail below. It will be appreciated by those skilled in the art that the UMR can be connected to the gateway 214 via an Ethernet connection, or by a wireless connection to a wireless router (not shown) that in turn is connected to the gateway 214 in a conventional manner. The UMR 214 may be adapted to transmit utility consumption data continuously, or at specified intervals established by the utility service providers. Alternatively, the UMR 214 may be programmed to respond to inquiries for consumption data that are transmitted to the customer premises over the IPTV network 216. Such inquiries may be generated at the USMC 114 or by the utility companies themselves 118. 120, 122 as shown in FIG. 1.

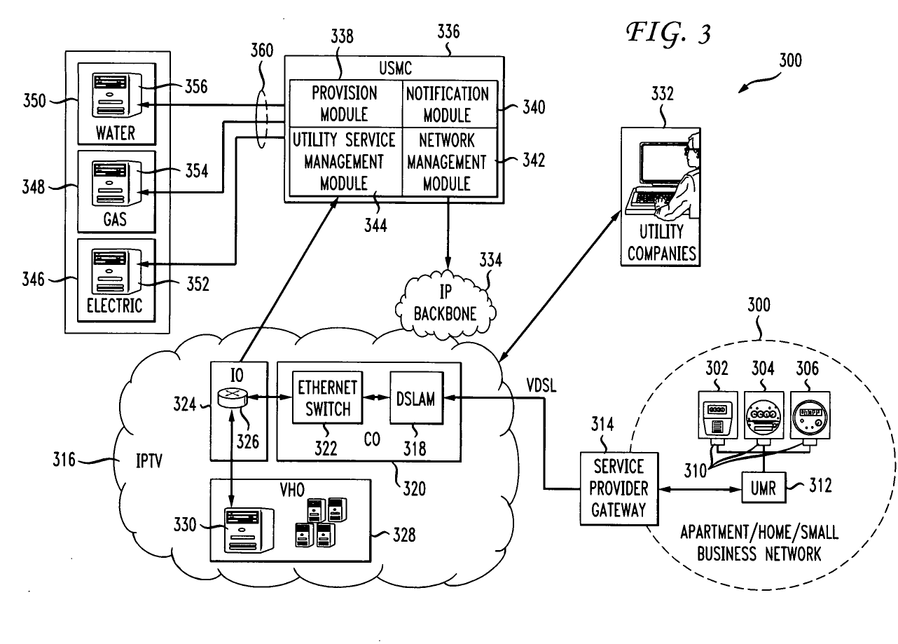

FIG. 3 is a schematic of an exemplary architecture including a home/small business/apartment network 300 that includes a gas meter 302, electric meter 304 and water meter 306 that are each coupled via respective data receiving devices 310 to a UMR 312 as described above. The UMR 312 is connected to a service provider gateway 314 that enables the transmission of collected consumption and other data to the IPTV network 316. The UMR 312 contains a processor that may format the collected data into various network protocols and formats. These can, for example, consist of web server HTML, XML or the like. The network formatted data is supplied over a network interface to the service provider gateway 314 such as an Ethernet interface that supports 100 base-T or 10 base-T communications. This type of network interface can send and receive data packets between WAN/LAN connections and the UMR 312/meter array.

The meter data includes, as described above, consumption data for the customer, but may also include periodic status data regarding the meter if so desired. In this manner appropriate alarms may be generated if a meter fails to inform the network of its status and a repair notice can be issued for the utility company to effectuate meter repairs.

In the exemplary embodiment, the IPTV network 316 comprises a Digital Subscriber Line Access Multiplexer (“DSLAM”) 318 located at a Central Office (CO) 320 that communicates with the service provider gateway 314. The DSLAM 318 is connected to an Ethernet switch 322 that couples the CO to an Intermediate Office (IO) 324 including at least one IPTV router 326. The IO 324 is connected to a Video Hub Office (VHO) 328 that serves as the regional/local head end for the IPTV services. The VHO 328 may be coupled to a video service office (VSO) for content aggregation and switching (not shown). In the exemplary embodiment, the VHO 328 includes at least one utility server 330 for storing and managing utility data. The utility server 330 maintains profiles of customers, meter readings and utility usage for each customer. The metrics data for each customer may be collected on a continuous, hourly, daily, or any other prearranged basis as established by the utility companies. This data can be accessed directly over the IP backbone 332 by utility company personnel as shown generally at 334. A USMC 336 also communicates with the utility server 330, and comprises a provisioning module 338, notification module 340, network management module 342, and utility service management module 344.

Customer profiles and provisioning data are entered into utility server 330 via the provisioning module 338.

The utility service management module 344 collects data from the utility server 330 and generates monthly, quarterly and annual reports on customer consumption that may be communicated directly to the respective utility companies 346 (electric), 348 (gas), and 350 (water) as shown schematically in FIG. 3. The utility service management module 344 is coupled to the respective utility companies' servers 352, 354 and 356 via an appropriate interface 360. The utility companies 346, 348 and 350 then generate billing for their customers or contract out this function to a third party billing service. Alternatively, the billing function can be implemented by the utility server and the billing information then communicated to the respective utility company via the utility service management module 344. The collection of telemetry data by the utility server 330 enables the generation of many types of reports, such as, without limitation, monthly reports with daily consumption and average consumption for the past month, quarterly reports with monthly average consumption and quarterly averages, annual reports with monthly or quarterly average consumption and annual averages, quarterly and annual trend reports on a per town or per zip code basis, total consumption per town and/or county, total consumption per state, and comparison charts and reports.

The utility service management module 344 can generate email notifications to the utility companies 346, 348 and 350 before, contemporaneous with, or after transmitting the data to the utility companies' servers 352, 354 and 356 if desired. Similarly, a meter alarm from a customer can result in an email notification being triggered by the network management module 342.

It will be appreciated by those skilled in the art that the utility server 330 can be accessed by utility customers directly over the Internet domain, thereby enabling such customers to directly monitor all of their utility consumption from a single location. This feature can be provided by their network service provider. For example, the customer can manage his or her TV, data, phone and utility consumption directly from the service provider's website links. For example, a Uniform Resource Locater (URL) such as http//www.HomeUtility.att.com may be provided in connection network services provided by AT&T for its IPTV customers. Similarly, this link is made available for access by the utility companies that have consumption data for their customers residing on utility server 330. A Web page accessible via that link preferably requires a user name or other suitable customer/utility identification and a password, or other security code associated with the user name prior to permitting access to consumption data.

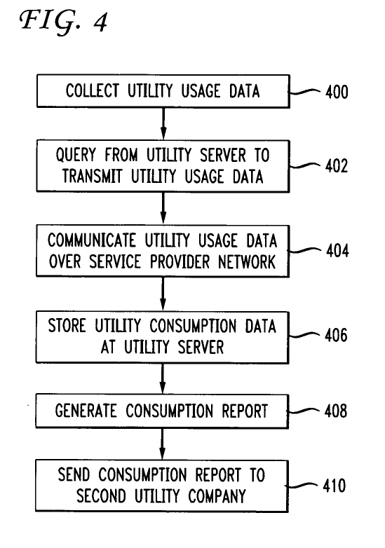

FIG. 4 is a flowchart of a method in accordance with an aspect of the invention for collecting utility consumption data over a customer's network. In step 400, usage data for water, gas and electric consumption is periodically or continuously recorded by the UMR described above from the respective water, gas and electric meters at the customer premises. In step 402, the UMR is queried for this data over the home network by commands that are communicated from the utility server residing with the network service provider. The requested consumption data is then communicated to the utility server at step 404, and stored in a database associated with the utility server at step 406. At step 408, the utility server generates a consumption report for each utility company. The consumption report, as discussed above, may be generated on a monthly, quarterly, and/or annual basis. In step 410, the consumption report for each utility company is communicated to the appropriate entity. Note, this may occur at different times for example, with a gas company and an electric company. Consumption reports may also be requested from the utility server at any time by accessing the same as described above.

The UMR may periodically or continuously upload consumption data to the utility server using a publish/subscribe network communications protocol, without waiting for a query from the utility server. It will also be appreciated by those skilled in the art that the use of a UMR for collecting usage data is merely exemplary. It is possible for each of the utility meters to be directly connected to the network gateway at the customer premises within the scope of the invention. A utility meter may itself include a processor adapted for communicating with a communications network via a network interface that in a preferred embodiment converts the data therein to an Ethernet TCP/IP format.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

We claim:

1. A method for collecting utility consumption telemetry data from a customer served by a plurality of utility companies, and providing a consumption report for the customer to each of the plurality of utility companies serving the customer, comprising the steps of:
receiving the utility consumption telemetry data from the utility customer at a server associated with a network service provider that provides the customer with networked communications;
storing the utility consumption telemetry data in a database; and
providing a consumption report for the customer to each of the plurality of utility companies serving the customer.

2. The method recited in claim 1, wherein the network service provider includes bundled home services.

3. The method recited in claim 2, wherein the bundled home services include voice, data and television.

4. The method recited in claim 1, wherein the consumption reports include at least one of monthly, quarterly and annual reports.

5. The method recited in claim 1, further comprising the step of receiving alarm data relating to the condition of a utility meter at the customer location.

6. The method recited in claim 1, further comprising the step of generating an email notification to each of the plurality of utility companies in connection with providing the consumption report.

7. The method recited in claim 5, further comprising the step of generating an email notification to a selected utility company in connection with receiving the alarm data relating to the condition of the utility meter at the customer location.

8. A system for collecting utility consumption telemetry data from a customer served by a plurality of utility companies, and providing a consumption report for the customer to each of the plurality of utility companies serving the customer, comprising:
a server associated with a network service provider that provides the customer with networked communications, adapted for receiving the utility consumption telemetry data from the utility customer, and storing the utility consumption telemetry data in a database; and
a module for providing a consumption report for the customer to each of the plurality of utility companies serving the customer.

9. The system recited in claim 8, wherein the network service provider includes bundled home services.

10. The system recited in claim 9, wherein the bundled home services include voice, data and television.

11. The system recited in claim 8, wherein the consumption reports include at least one of monthly, quarterly and annual reports.

12. The system recited in claim 8, adapted to generate an email notification to each of the plurality of utility companies in connection with providing the consumption report.

13. The system recited in claim 8, adapted to generate an email notification to a selected utility company in connection with receiving alarm data relating to the condition of a utility meter for the selected utility company at the customer location.

14. A system for collecting utility consumption telemetry data from a customer served by a plurality of utility companies, and providing a consumption report for the customer to each of the plurality of utility companies serving the customer, comprising:
a plurality of utility meters disposed at the customer location, the utility meters communicating with a service provider network serving the customer; and
a network service provider gateway coupled to the plurality of utility meters, the network service provider gateway enabling the delivery of bundled network services to the customer.
